(19) United States
(12) Patent Application Publication
(10) Pub. No.: US 2007/0017757 A1
(43) Pub. Date: Jan. 25, 2007

(54) Spring-actuated brake cylinder

(76) Inventors: Frank Schrader, Isernhagen (DE); Oliver Brandt, Braunschweig (DE); Jurgen Ewald, Laatzen (DE); Wilfried Matthias, Bad Nenndorf (DE); Andreas Richter, Wedemark (DE)

Correspondence Address: Kramer Levin Naftalis & Frankel LLP, 1177 Avenue of the Americas, New York, NY, 10036, US

(21) Appl. No.: 11/489,240

(22) Filed: Jul. 18, 2006

(30) Foreign Application Priority Data
Jul. 20, 2005 (DE) 10 2005 033 848.8

(51) Int. Cl. F16D 65/24

(52) U.S. Cl. 188/170; 188/67; 188/265; 303/89; 303/9.76; 92/24

(57) ABSTRACT

A spring-actuated brake cylinder having a housing with a first housing part in which there is formed a spring chamber containing an actuator spring that acts on a spring-actuated piston, and with a second housing part in which there is formed a pressure chamber, the housing parts being provided with outwardly extending rim flanges that can be connected to one another. The second housing part is made from deformable plate material and has an adequately dimensioned rim flange which is crimped onto and circumferentially around the rim flange of the first housing part by exceeding its elastic limit.

### BACKGROUND OF THE INVENTION

The present invention relates generally to a spring-actuated brake cylinder for use in vehicle brake systems.

Spring-actuated brake cylinders of the general type under consideration are known to include a spring chamber, which is formed in a first housing part and in which there is disposed an actuator spring that acts on a spring-actuated piston, as well as a pressure chamber, which is formed in a second housing part. The pressure chamber and spring chamber can be separated by a diaphragm clamped between the two housing parts such that it is in dynamic communication with the spring-actuated piston. Such spring-actuated brake cylinders are used to actuate a parking brake.

In the pressurized pressure chamber, the actuator spring is compressed to a condition in which it represents considerable potential energy. In the event of pressure loss in the brake system, the actuator spring moves the spring-actuated piston, whereby the vehicle brake is actuated via a push rod. To ensure that the potential energy built up by the compressed actuator spring cannot dissipate in uncontrolled manner, leading to the risk that the housing part will break apart due to the large spring force or the system pressure of the brake system, there is particular value in a tamper-proof connection of the two housing parts. Such a connection should also prevent the potential for leaks caused by manipulation, since leaks could trigger unwanted braking events.

U.S. Pat. No. 5,067,391 describes a spring-actuated brake cylinder in which a first housing part receiving the actuator spring is manufactured from sheet steel by deep-drawing. An adjoining second housing part receiving the pressure chamber is made from cast metal, such as cast aluminum. Outwardly protruding rim flanges are formed on both housing parts, between which a diaphragm is clamped. The rim flange of the first housing part of sheet steel is crimped onto and circumferentially around the rim flange of the second housing part of cast metal. U.S. Pat. No. 5,067,391 also describes how to connect the rim flanges of both housing parts using a clamping ring. In both cases, the clamping means is deformed beyond its elastic limit. The use of cast metal increases the manufacturing costs, since expensive castings need to be manufactured.

DE 3404014 A1 describes a combined single-chamber diaphragm-type brake cylinder and spring-actuated brake cylinder, in which two housing parts clamping a diaphragm are connected to one another by means of a clamping ring having a U-shaped cross section as well as legs that embrace rim flanges of the two housing parts. The clamping ring represents an additional component and increases the cost as well as the time and effort needed for assembly.

DE 3026596 A1 describes a diaphragm-type cylinder comprising a cover and a cylindrical case. The cover and the cylindrical case are connected to one another by a snap fit connection in such a way that an axially extending slit snap ring is formed on the cover. This snap ring is slit in order to form a plurality of hooks. The extensions of these hooks embrace a collar formed on the cylindrical case and extending on the outside circumference thereof. In addition, a band clamp is disposed on the outside circumference of the snap ring, and can be tightened as desired in order to clamp the diaphragm between the cover and cylindrical case. In another embodiment of a diaphragm-clamping system, there is provided, on the outside circumference of the collar, a thread onto which a band with a corresponding thread can be screwed. For this connection, two additional components are required—increasing the manufacturing cost as well as the time and effort needed for assembly.

The types of connection of the two housing parts described in the latter two references noted above are not tamper-proof. That is, they are not secured against unauthorized adjustment, and so, potentially, the connection can be loosened by relatively simple manipulation, creating the risk that the cover will fly off due to sudden expansion of the compression spring or due to the system pressure.

### SUMMARY OF THE INVENTION

Generally speaking, it is an object of the present invention to provide a tamper-proof, easy-to-assemble and cost-effective means for connecting two housing parts of a spring-actuated brake cylinder that can be manufactured simply and inexpensively.

In accordance with one embodiment of the present invention, the housing part that receives the pressure chamber and is typically made of cast metal is instead manufactured from deformable plate material, for example by deep-drawing, and the rim flange of this housing part is crimped onto and circumferentially around the rim flange of the housing part that receives the spring chamber containing the actuator spring by deforming the encircling crimped rim flange beyond its elastic limit. One advantage of this approach is that the cast metal housing part, which is relatively time-consuming and expensive to manufacture, is replaced by a sheet-steel housing part that is manufactured simply by deep-drawing and that can be easily adapted to different size conditions. Crimping the rim flange of the housing part receiving the pressure chamber onto and circumferentially around the rim flange of the housing part receiving the actuator spring is advantageous in view of the sequence of assembly of a spring-actuated brake cylinder of the type under consideration.

In accordance with another embodiment of the present invention, the rim flange of one housing part is provided with a threaded portion. A clamping ring having a mating thread configured for threaded engagement with the threaded rim flange is provided for connecting the rim flanges of the two housing parts. The ring is provided with a cylindrical portion on which the mating thread is formed, and with an annular bend formed on the cylindrical portion, such that the ring can be screwed onto the threaded rim flange whereupon the bend embraces the rim flange of the other housing part and pulls it toward the threaded rim flange.

In accordance with further embodiments of the present invention, the rim flange of one housing part is provided with a circumferential groove into which one or more snap fit elements formed on the rim flange of the other housing part snap when the rim flange of the one housing part is introduced onto or inserted into the rim flange of the other housing part. The snap fit elements can be formed by tongues which are created by U-shaped incisions in the bend and whose free ends are offset slightly inwardly. The snap fit elements can also be shaped as hooks.

Still other objects and advantages of the present invention will in part be obvious and will in part be apparent from the specification.

The present invention accordingly comprises the features of construction, combination of elements, and arrangements of parts which will be exemplified in the constructions hereinafter set forth, and the scope of the invention will be indicated in the claims.

### BRIEF DESCRIPTION OF THE DRAWINGS

For a fuller understanding of the present invention, reference is had to the following description taken in connection with the accompanying drawings in which:

FIG. 1 is a cross-sectional view of a connection of two housing parts of a spring-actuated brake cylinder in accordance with one embodiment of the present invention;

FIG. 2 is an enlarged view of area “A” of the embodiment of the present invention depicted in FIG. 1;

FIG. 3 is a cross-sectional view of a connection of two housing parts of a spring-actuated brake cylinder in accordance with another embodiment of the present invention;

FIG. 4 is an enlarged view of area “B” of the embodiment of the present invention depicted in FIG. 3;

FIG. 5 is a cross-sectional view of a connection of two housing parts of a spring-actuated brake cylinder in accordance with yet another embodiment of the present invention;

FIG. 6 is an enlarged view of area “C” of the embodiment of the present invention depicted in FIG. 5;

FIG. 7 is a side view of the embodiment of the present invention depicted in FIG. 5; and

FIGS. 8 and 9 depict a clamping system in accordance with one embodiment of the present invention.

### DETAILED DESCRIPTION OF THE PREFERRED EMBODIMENTS

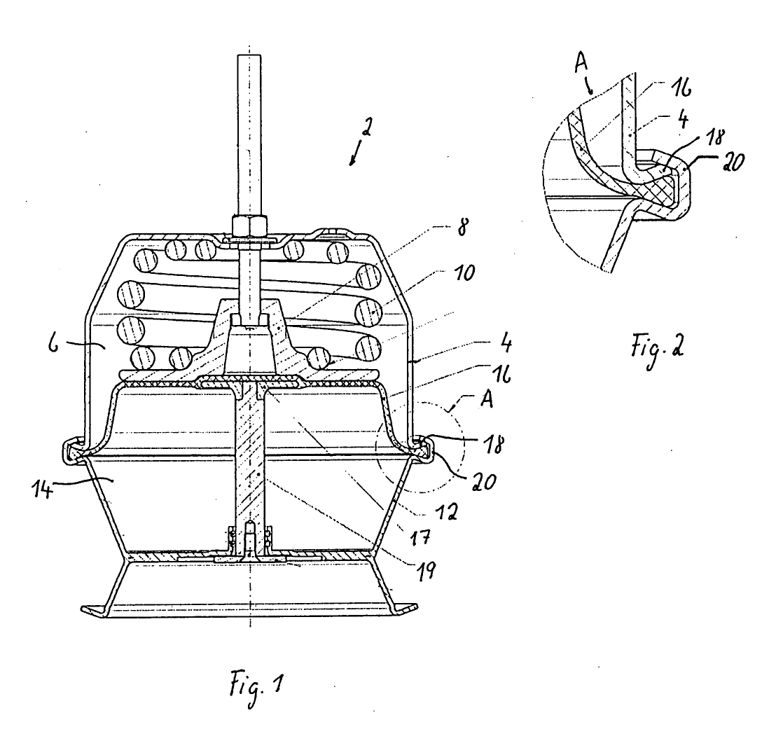

Referring to the drawing figures, where like reference numerals are used for corresponding parts, FIGS. 1 and 2 depict embodiments of a spring-actuated air-brake cylinder 2 having a first housing part 4, in which there is formed a spring-actuator chamber 6 containing an actuator spring 10 that acts on a spring-actuated piston 8, a second housing part 12, in which there is formed a pressure chamber 14, and a spring-actuator diaphragm 16 clamped between the two housing parts. A push rod 19 provided with a pressure member 17 is moveably guided in the pressure chamber. The two housing parts 4 and 12 are made from sheet steel and are manufactured by a deep-drawing method.

The two housing parts 4, 12 are provided with outwardly extending circumferential rim flanges 18, 20, respectively, between which diaphragm 16 is clamped. In order to establish a tamper-proof connection between the two housing parts 4, 12, or in order to connect the two housing parts to one another in a manner secure against unauthorized adjustment, rim flange 20 of second housing part 12 is crimped upwardly onto and circumferentially around rim flange 18 of first housing part 4 by deforming the crimped flange beyond its elastic limit.

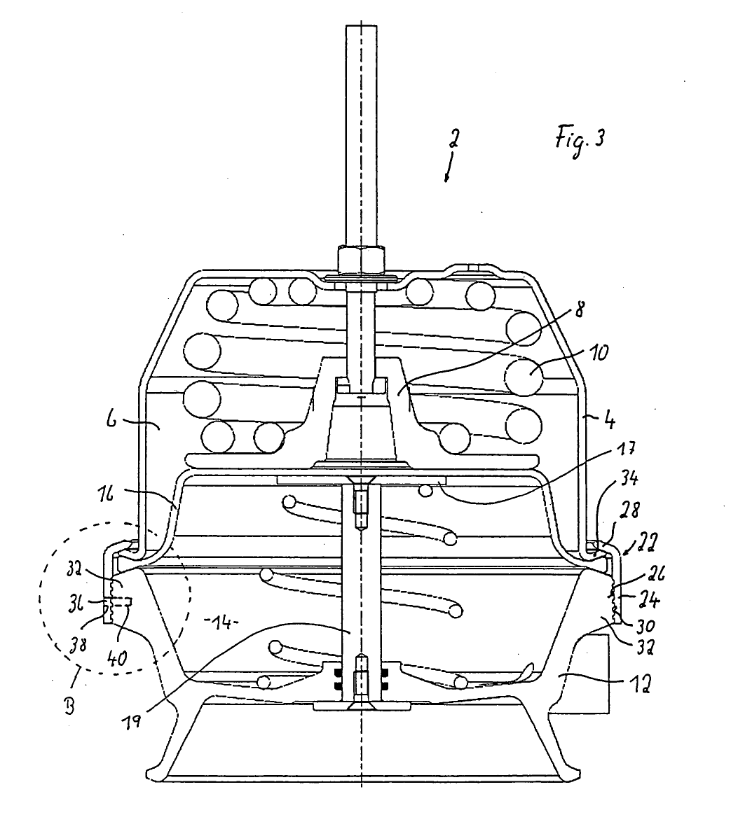

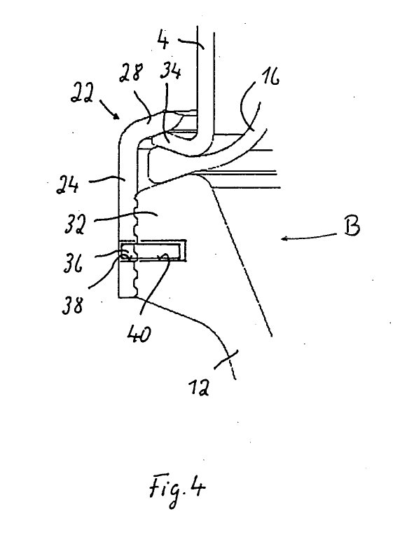

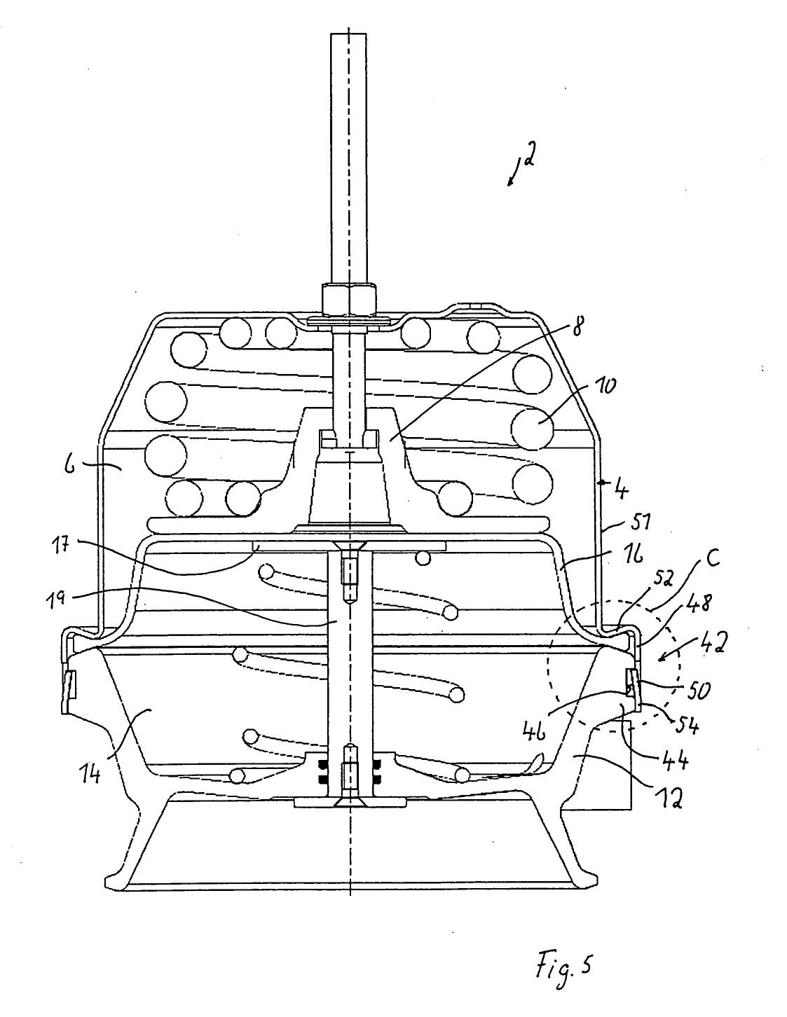

FIGS. 3 and 4 show an embodiment of spring-actuated brake cylinder 2 in which first housing part 4 and second housing part 12 are connected by means of a clamping ring 22, comprising a cylindrical portion 24 which is equipped with a thread 26 and on which there is formed an inwardly projecting annular bend 28. By means of its thread 26, clamping ring 22 is screwed in the manner of a union nut onto a mating thread 30 of a rim flange 32 of the one housing part, in this case second housing part 12, whereupon bend 28 embraces a rim flange 34 of the other housing part, in this case first housing part 4.

As a safeguard against unauthorized opening, there is provided at least one pin 36, which can be guided through an opening 38 formed in cylindrical portion 24 of clamping ring 22 into a blind hole 40 of rim flange 32 of housing part 12, and which at the outside at least forms a closure flush with the outside face of clamping ring 22.

In another possible tamper-proof embodiment, there is provided a free-running end that adjoins thread 26.

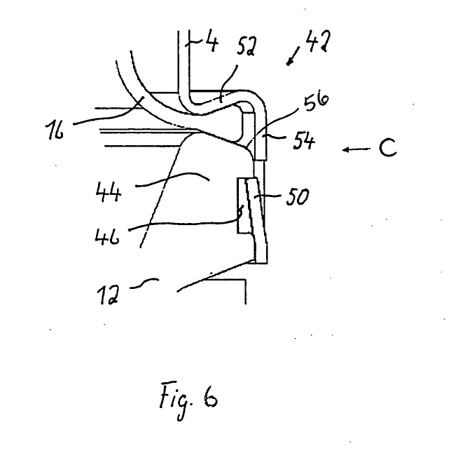

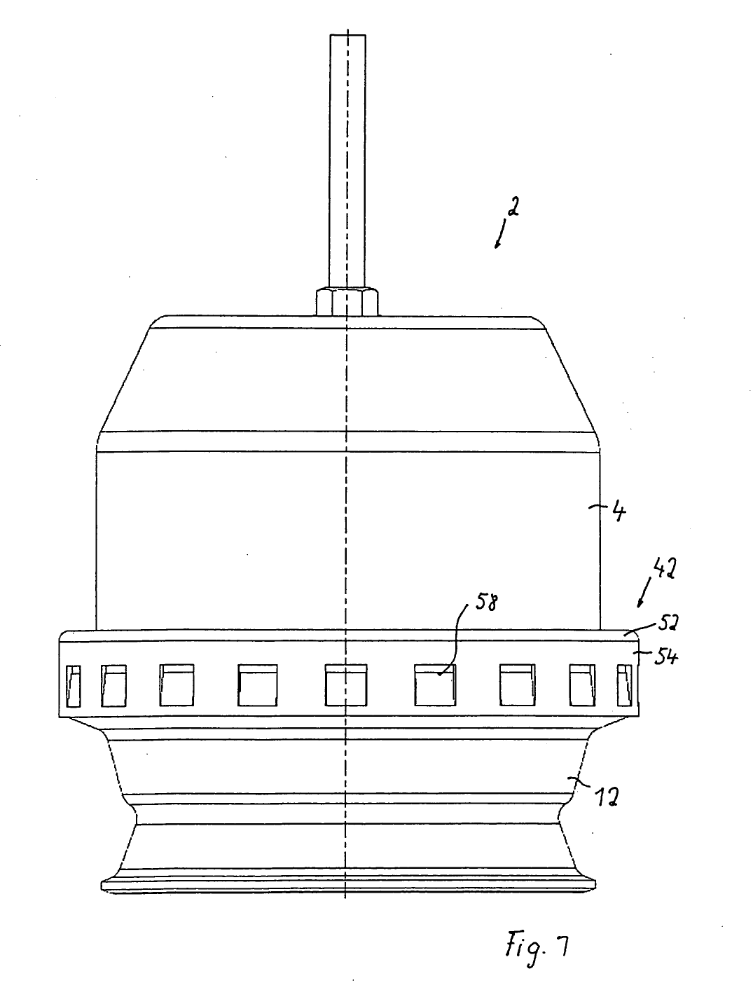

FIGS. 5, 6 and 7 show an embodiment of a tamper-proof connection of the two housing parts 4, 12, using a clamping system 42 that represents a tongue-and-groove type connection, and that is provided with a circumferential groove 46 formed on a rim flange 44 of the one housing part, in this case second housing part 12, and with at least one snap-in element 50 associated with circumferential groove 46 and formed in rim flange 48 of the other housing part, in this case first housing part 4.

In order that it can be pushed over rim flange 44 of second housing part 12, rim flange 48 of first housing part 4 has a bent shape, comprising an annular part 52 projecting away from housing shell 51 and an annular bend 54, which extends away from part 52 toward the other housing part 12 and which, in assembled condition, embraces rim flange 44 of second housing part 12. Rim flange 44 of second housing part 12 is provided on the rim pointing opposite the “push on” direction with a chamfer 56 by means of which it is easier to push bend 54 of rim flange 48 of first housing part 4 onto and over rim flange 44 of second housing part 12.

Snap-in elements 50 are preferably created by U-shaped incisions to form tongues 58 whose free ends are offset slightly inwardly. To connect the two housing parts 4, 12, first housing part 4 is pushed with rim flange 48, or with bend 54 thereof, over rim flange 44 of second housing part 12, whereupon bend 54 of rim flange 48 slides over chamfer 56 of rim flange 44 and snaps with its tongues 58 into groove 46 in tamper-proof manner, while simultaneously clamping diaphragm 16.

It should be understood that, although the practical examples described herein relate to diaphragm-type spring-actuated brake cylinders, the described means for connecting the two housing parts are equally applicable to diaphragm-free spring-actuated brake cylinders.

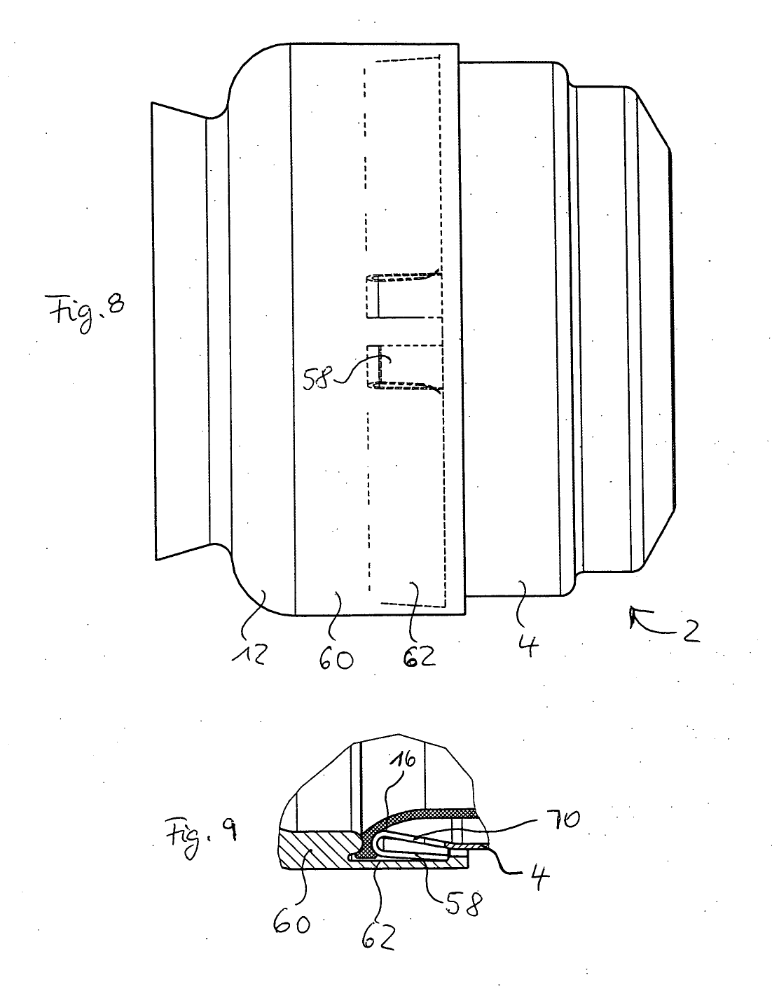

FIGS. 8 and 9 show an alternative embodiment of clamping system 42 described with reference to FIGS. 5, 6 and 7 above in which snap-in element 50 as well as a circumferential groove 62 is disposed in concealed manner. In the embodiment depicted in FIGS. 8 and 9, a part 60 of second housing part 12 embracing first housing part 4 is provided with an internal circumferential groove 62, which is also referred to as a plunge cut. On first housing part 4 there are disposed, in a manner distributed over the circumference, snap fit elements 70 which are provided with outwardly directed tongues 58 designed to snap into circumferential groove 62. As is evident from FIG. 9, snap fit elements 70 can advantageously have the shape of hooks.

For assembly of spring-actuated compressed-air cylinder 2, first housing part 4 is inserted into second housing part 12 until snap fit elements 70 snap in place and create a brake-cylinder device secured against inadvertent opening. By appropriate shaping of part 60 of first housing part 12 as well as of snap fit elements 70 (with tongues 58), diaphragm 16 is simultaneously fixed, in the manner shown in FIG. 9, during assembly of the two housing parts.

It should be appreciated that the type of tamper-proof connection of the housing parts of a spring-actuated brake cylinder described herein is suitable for all types of spring-actuated brake cylinders, especially for diaphragm-type cylinders and also for piston-type cylinders.

Accordingly, the present invention achieves a tamper-proof, easy-to-assemble and cost-effective means for connecting two housing parts of a spring-actuated brake cylinder that can be manufactured simply and inexpensively.

It will thus be seen that the objects set forth above, among those made apparent from the preceding description, are efficiently attained, and since certain changes may be made in the above constructions without departing from the spirit and scope of the invention, it is intended that all matter contained in the above description or shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

What is claimed is:

1. A spring-actuated brake cylinder, comprising a housing having a first housing part, a spring chamber defined in said first housing part, an actuator spring in said spring chamber, a spring-actuated piston acted on by said actuator spring, a second housing part, and a pressure chamber defined in said second housing part, said first and second housing parts including outwardly extending rim flanges, said second housing part being formed from a deformable plate material, said rim flange of said second housing part being deformable onto and circumferentially around said rim flange of said first housing part by exceeding an elastic limit of said rim flange of said second housing part.

2. The spring-actuated brake cylinder according to claim 1, further comprising a diaphragm clamped circumferentially between said rim flanges of said first and second housing parts in dynamic communication with said spring-actuated piston.

3. A spring-actuated brake cylinder, comprising a housing having a first housing part and a second housing part, said first and second housing parts including outwardly extending rim flanges, said rim flange of said second housing part including a threaded portion, and a clamping ring including a cylindrical portion having a threaded area defined thereon configured for threaded engagement with said threaded portion of said rim flange of said second housing part for connecting said rim flanges of said first and second housing parts, said clamping ring including an annular bend formed on said cylindrical portion configured to embrace said rim flange of said first housing part and pull it toward said rim flange of said second housing part when said clamping ring is threadably fastened to said rim flange of said second housing part.

4. The spring-actuated brake cylinder according to claim 3, wherein said first housing part includes a spring chamber defined therein, an actuator spring in said spring chamber, a spring-actuated piston acted on by said actuator spring, and said second housing part includes a pressure chamber defined therein.

5. The spring-actuated brake cylinder according to claim 3, further comprising at least one pin insertable through at least one opening defined in said cylindrical portion of said clamping ring into at least one blind hole defined in said rim flange of said second housing part such that said at least one pin forms a closure that is substantially flush with an outside surface of said cylindrical portion to secure said clamping ring.

6. The spring-actuated brake cylinder according to claim 3, further comprising a free-running end adjoining said threaded area of said cylindrical portion to secure said clamping ring.

7. The spring-actuated brake cylinder according to claim 3, wherein said rim flange of said second housing part is deformable onto and circumferentially around said rim flange of said first housing party by at least one of crimping, clawing and pressing.

8. A spring-actuated brake cylinder, comprising a housing having a first housing part and a second housing part, said first and second housing parts including outwardly extending rim flanges, said rim flange of said first housing part including at least one snap fit element, said second housing part including a circumferential groove defined therein for engaging said at least one snap fit element on said rim flange of said first housing part when said rim flange of said first housing part is introduced onto said rim flange of said second housing part.

9. The spring-actuated brake cylinder according to claim 8, wherein said first housing part includes a spring chamber defined therein, an actuator spring in said spring chamber, a spring-actuated piston acted on by said actuator spring, and said second housing part includes a pressure chamber defined therein.

10. The spring-actuated brake cylinder according to claim 8, wherein said rim flange of said first housing part includes an outwardly projecting annular portion extending into an annular bend projecting away from said annular portion toward said second housing part to fit over said rim flange of said second housing part.

11. The spring-actuated brake cylinder according to claim 10, wherein said at least one snap fit element is formed from at least one U-shaped incision in said annular bend of said rim flange of said first housing part to form at least one tongue having a free end offset slightly inwardly.

12. The spring-actuated brake cylinder according to claim 8, wherein said rim flange of said second housing part includes a chamfer.

13. A spring-actuated brake cylinder, comprising a housing having a first housing part and a second housing part, said first and second housing parts including outwardly extending rim flanges, said rim flange of said first housing part including at least one snap fit element having an outwardly projecting tongue, said second housing part including an internal circumferential groove defined therein for engaging said tongue of said at least one snap fit element when said first housing part is inserted into said second housing part.

14. The spring-actuated brake cylinder according to claim 13, wherein said first housing part includes a spring chamber defined therein, an actuator spring in said spring chamber, a spring-actuated piston acted on by said actuator spring, and said second housing part includes a pressure chamber defined therein.

15. The spring-actuated brake cylinder according to claim 13, further comprising a diaphragm clamped circumferentially between said at least one snap fit element and said second housing part.

16. The spring-actuated brake cylinder according to claim 13, wherein said at least one snap fit element is hooked shaped.
